(19) United States
(12) Patent Application Publication
(10) Pub. No.: US 2012/0037840 A1
(43) Pub. Date: Feb. 16, 2012

(54) USE OF MAGNETIC NANOPARTICLES TO REMOVE ENVIRONMENTAL CONTAMINANTS

(76) Inventors: Galen Stucky, Santa Barbara, CA (US); Arturo A. Keller, Santa Barbara, CA (US); Yifeng Shi, Hangzhou (CN); Peng Wang, Thuwal (SA); Qihui Shi, Shanghai (CN); Hongjun Liang, Arvada, CO (US)

(21) Appl. No.: 12/918,291

(22) PCT Filed: Feb. 25, 2009
(86) PCT No.: PCT/US09/01208

§ 371 Date: Nov. 1, 2011

Related U.S. Application Data
(60) Provisional application No. 61/066,962, filed on Feb. 25, 2008.
(60) Provisional application No. 61/188,226, filed on Aug. 7, 2008.

(51) Int. Cl. B03C 1/32; H01F 1/01; H01F 1/20; B01D 15/36; B03C 1/015; D01F 9/12; B82Y 40/00; B82Y 25/00; B82Y 30/00

(52) U.S. Cl. 252/62.53; 209/8; 252/62.59; 423/447.1; 210/656; 977/895; 977/773; 977/902; 977/742; 977/750; 977/752; 977/734; 977/845

(57) ABSTRACT

Methods and compositions for removing a contaminant from its environment. The method includes forming a magnetic composition comprising the contaminant and an amphiphilic substance, and applying a magnetic field to the magnetic composition so as to separate the magnetic composition from the environment. One composition includes a micelle array confined in a magnetic mesoporous framework. Another composition is formed by adhering an amphiphilic material comprising functional surface groups to a contaminant, then interacting a magnetic material with the functional surface groups of the amphiphilic material. In various versions, the contaminant can be a hydrophobic organic compound, or a fullerene-related nanoparticle. The methods can also be used to purify hydrophobic organic compounds or fullerene-related nanoparticles.

### CROSS-REFERENCE TO RELATED APPLICATIONS

This application claims the benefit of Provisional Patent Application Nos. 61/066,962, filed Feb. 25, 2008, and 61/188,226, filed Aug. 7, 2008, which are all incorporated by reference herein.

### STATEMENT REGARDING FEDERALLY SPONSORED RESEARCH OR DEVELOPMENT

This invention was made with U.S. Government support under Grant No. NCC-1-02037 from NASA University Research, Engineering and Technology Institute on Bio Inspired Materials (BIMat). The U.S. Government has certain rights in this invention.

### BACKGROUND

1. Field of Invention

This invention relates generally to magnetic removal of particles from their surroundings.

2. Related Art

During the last few decades the production of synthetic organic chemicals has grown dramatically. However, the manufacture, transport, retailing, and end-of-life activities of these chemicals are not well controlled, resulting in spills, accidental or even intentional releases at various points into the environment. Hydrophobic organic compounds (HOCs) are among the most common environmental contaminants. The main characteristic that differentiates HOCs from other contaminants is that they are hydrophobic and therefore are sparsely soluble in water. For this reason, once in the environment (water, soil, sediment, and the like), they tend to sorb strongly onto solid particles (e.g. water colloids, soil, sediments). Natural organic matter associated with these particles is believed to be the most important phase for HOC sorption. Furthermore, it has been extensively reported that sorbed HOCs are much more persistent than the dissolved compounds and are usually not bioavailable for natural or enhanced biodegradation, which makes the clean-up of HOC contamination very challenging [1]. It is also for this reason that many HOCs have become very widespread environmental contaminants, especially in soils and sediments.

The treatment efficiency of conventional remediation technologies, such as pump and treat, soil sparging, soil vapor extraction, bioremediation, and ex situ soil washing, are limited for HOC-contaminated soils and sediments due to the low water solubility and high sorption of HOCs.

Surfactant molecules are amphiphilic, containing hydrophilic heads and hydrophobic (or lipophilic) tails. At low concentrations, surfactants are present as monomers, or dispersed individual molecules; above a critical aqueous concentration, specific to each surfactant, the critical micelle concentration (CMC), surfactant monomers aggregate in solution to form micelles, which contain a hydrophobic core and a hydrophilic corona. The hydrophobic micelle cores have been demonstrated to be a very effective medium for HOC to partition into. FIG. 1 presents a three dimensional schematic representation of a typical micelle structure. FIG. 2 shows the water solubility enhancement of a HOC (diuron, one of the most commonly used hydrophobic pesticides) in the presence of a cationic surfactant (benzalkonium chloride) [1]. As shown, with a benzalkonium chloride concentration of 6.0 g/L, the solubility of diuron was about 20 times as much as that in absence of the surfactant. The ability of surfactant micelles to enhance the water solubility of HOCs provides a potential means of HOC decontamination. As a result, surfactant-aided soil washing systems have been developed for remediating HOC-contaminated soils and sediments ex situ. [3-4]

However, it has been found that many surfactants (e.g., nonionic and cationic) can themselves sorb strongly onto soils and sediments [5-8] and that sorption takes place in the form of surfactant monomers. Sorption of surfactants onto soils and sediments results in surfactant loss and thus reduced performance for the solubilization of HOCs for a surfactant-aided soil washing system. More importantly, the sorbed surfactants can serve to increase the organic matter content of the soil and sediment particles, which serves undesirably as a new partitioning medium for HOCs [2, 5-8]. FIG. 3 presents a diagram describing HOC partitioning within a soil-water-surfactant system (the interaction between HOC and surfactant monomers is insignificant for most HOCs and it is for this reason that the arrows between HOC and monomers are dashed).

It has been reported that the surfactant-derived organic matter was 10 to 30 times more effective on a unit weight basis than natural soil organic matter for sorbing HOCs [7, 17]. Therefore, instead of extracting the sorbed HOCs from soils and sediments, surfactant sorption onto the soils causes the HOCs to be accumulated in the soil and sediment phase as the surfactant sorption increases. The surfactant sorption saturation is reached when the equilibrium surfactant aqueous concentration is equal to the CMC of the surfactant. As such, before the surfactant sorption saturation is reached, the presence of the surfactant actually works against the remediation goal of soil washing systems, which is to desorb the HOCs out of their original sorbed phase. As a result, significantly greater amount of surfactant is needed to overcome the sorption of the HOCs onto the soil-sorbed surfactant phase to achieve the remediation goal. FIG. 4 presents the diuron aqueous concentrations as a function of the equilibrium surfactant concentrations within a soil-water-surfactant system [1]. As shown, the CMCs of Triton X-100 (nonionic) and benzalkonium chloride (cationic) are 0.12 g/L and 0.55 g/L, respectively, where Ag#1, Ag#2, Ag#3, Clayey represent four agricultural soils while Sediment represents a sediment sample.

As shown in FIG. 4, before the CMCs of the surfactants were reached in the aqueous phase, as the surfactant aqueous concentrations increased, the diuron aqueous concentrations decreased sharply, indicating the amount of diuron sorbed increased correspondingly, which was caused by the surfactant sorbed onto the soils or sediment. Once the surfactant CMCs were reached, the diuron aqueous concentrations started increasing, suggesting a decrease in the amount of diuron sorbed. It is only beyond this point that the HOC is actually washed off the soil or sediment particles. Thus, for enhanced HOC desorption to occur, the initial aqueous surfactant concentration has to be much greater than that assuming there is no surfactant sorption, given significant amount of surfactant loss to the sorption onto soil or sediment.

Furthermore, previous studies have shown that within a surfactant-aided soil washing system, it is the amount of the surfactant sorbed, not the amount of HOC originally sorbed on the soils or sediments before the soil washing takes place, that determines the total amount of surfactant to be used to achieve the remediation goals [5]. Thus, the sorption of surfactant has been the biggest obstacle for the surfactant-aided soil washing technology. In many cases, the amount of sorbed surfactant is so high that it renders the surfactant-aided soil washing virtually ineffective.

Generally, positive charged cationic surfactants are able to sorb onto soil and sediment particles, which are usually negatively charged, to a higher extent than nonionic surfactants. For this reason, cationic surfactants are much less desirable for a surfactant-aided soil washing system even though in many cases, the micelles of some cationic surfactants have significantly greater HOC solubility enhancement than those of nonionic and anionic surfactants. On the other hand, although the loss of anionic surfactants (e.g. linear alkylbenzene sulfonate (LAS) and sodium dodecyl sulfonate (SDS)) by sorption onto soils and sediment might be low, the loss via complexation with divalent cations in soils (e.g., Ca²⁺, Mg²⁺) can be so significant that the use of anionic surfactants for remediating contaminated soils which are rich in divalent cations is typically ineffective [9, 10].

Furthermore, surfactant micelles are present in aqueous phase and cannot be separated from bulk water phase and thus the final products of a surfactant-aided soil washing are a significant amount of HOC-containing water and/or a smaller volume of fine particles to be further treated and disposed of Further treatment of these final products is not trivial; it involves significant treatment costs.

Another group of compounds that may act as contaminants include fullerenes and related compounds. Carbon nanotubes (CNTs) are important structural blocks for the preparation of composites with unique optical, electrical, and mechanical properties and their production is expected to increase drastically in the years to come [11]. This will undoubtedly increase the risk of human and environmental exposure to CNTs [12]. CNTs are extremely hydrophobic and prone to aggregation, as they are subject to higher van der Waals forces along the length axis, and therefore are not readily dispersed in aqueous or non-aqueous solutions, which has been the biggest obstacle for the application of CNTs in industry [13]. As a result, significant attention has been directed to the methods of CNT solubilization and two methods of exohedral functionalization or derivativization of CNTs have been developed to stabilize them; namely, covalent and non-covalent methods. Non-covalent methods are more desirable since they incur little damage to the CNTs' intrinsic structures and properties. So far, the stabilizing agents tested in the laboratory for non-covalent functionalization of CNTs include surfactants, synthetic polymers and biopolymers. Even though a number of studies have shown that CNTs are biologically active and cause toxic responses in some cell cultures [14], CNTs are seldom considered as potential environmental toxins in the aqueous and soil environment because of their strong hydrophobicity and propensity to form insoluble aggregates in aqueous solution.

Although nanoparticles such as carbon nanotubes (CNTs), fullerenes (C60) and carbon black (CB) can be beneficial when used in confined conditions, they may have undesirable effects when released into the environment. Recent work has shown that amphiphilic compounds such as Natural Organic Matter (NOM), especially its major component, humic acid (HA), and surfactants and certain polymers, have the ability to strongly adsorb to these nanoparticles. The coated nanoparticles can be easily dispersed in aqueous solutions in stable dispersions which can migrate through the environment and may not be filtered in conventional treatment systems. Thus, the presence of these nanoparticles in aqueous environment is a concern. The transport of CNTs in the presence of HA can be summarized as follows. CNTs remain stable in aqueous solutions once stabilized by HA, and mobile within porous media. Even though the HA-stabilized CNTs deposited onto the porous medium to a significant extent under high bulk ionic strength, under transit environmental conditions (e.g., precipitation, irrigation), the deposited CNTs might detach from the medium surfaces and get transported further. In view of this, stabilized HA-stabilized CNTs are expected to transport though a long distance and at large scale, and therefore the presence of CNTs in natural ground waters, surface waters and even drinking supplies can be expected. Given the demonstrated toxic response, the presence of CNTs in ambient water is a concern, especially in the context of significant increase of industrial production and expected release to the environment.

Considering possible toxic responses and the predicted increased production and release of CNTs into the environment, of particular concern are two recent separate studies [15,16] reporting that natural organic matter, especially its major component humic acid (HA), can stabilize CNTs in the aqueous phase. HA constitutes a major fraction of soil organic matter and of surface water organic matter and is the most abundant naturally occurring organic macromolecule on earth. Therefore, the ubiquitous presence of HA will tend to facilitate the solubilization of CNTs in the environment, and reconsideration of the environmental behaviors of CNTs and their potential environmental toxicity is appropriate especially within a framework where NOM and HA play a central role. The results of the inventors' own research has shown that HA-stabilized CNTs can transport for longer distances than previously thought, and therefore the presence of CNTs in natural ground waters, surface waters and even drinking supplies can be expected. Given the potential toxic response, the presence of CNTs in ambient water is a concern, especially in the context of significant increases of industrial production and possible releases to the environment.

### SUMMARY

Methods and compositions are provided for separating contaminants or compounds from their surroundings through magnetic interactions. For example, in view of the capability of surfactant to enhance the water solubility of hydrophobic organic compounds, and the drawbacks of the conventional surfactant-aided soil washing systems, in accordance with one embodiment of this invention, magnetic permanently confined micelle arrays (Mag-PCMAs) are used to concentrate and confine large amounts of surfactant micelles in a small volume for hydrophobic organic compound removal. Also, in view of the potential toxicity of carbon nanotubes and related nanoparticles, a method is provided in another embodiment to remove dispersed nanoparticles from contaminated solutions utilizing the strong interaction of magnetic materials with functional surface groups of amphiphilic compounds that are adhered to a wide range of nanoparticles.

In one aspect, a method of removing a contaminant from its environment is provided. The method includes forming a magnetic composition comprising the contaminant and an amphiphilic substance, and applying a magnetic field to the magnetic composition so as to separate the magnetic composition from the environment. In some embodiments, the contaminant is a hydrophobic organic compound, and in these embodiments, the magnetic composition can be prepared by adsorbing the hydrophobic organic compound into a micelle array confined in a magnetic mesoporous framework. In embodiments involving a hydrophobic organic compound, micelles of the micelle array can be physically confined, chemically confined, or both physically and chemically confined, within the mesoporous framework. In some embodiments, the micelle array can include a surfactant. Embodiments involving a hydrophobic organic compound can comprise a magnetic composition that further includes a grafted monolayer or a polymer brush for enabling heavy metal decontamination and organic matter removal. Further, embodiments involving a hydrophobic organic compound can have a magnetic composition that includes a core/shell structure, which in certain embodiments includes an iron oxide core, a silica mesoporous framework, and a cationic surfactant-containing micelle array. In various embodiments, a micelle array can be part of a nanoparticle or microparticle.

In another aspect, the contaminant itself is in the form of a nanoparticle. In these embodiments, the nanoparticle contaminant can be a single-walled carbon nanotube, a multi-walled carbon nanotube, a fullerene, carbon black or a carbon black-type material, a boron nitride particle, or any derivative or combination thereof. In embodiments involving a nanoparticle contaminant, forming the magnetic composition includes adhering an amphiphilic material comprising functional surface groups to the contaminant, then interacting a magnetic material with the functional surface groups of the amphiphilic material. In some embodiments, the amphiphilic material can be natural organic matter, humic acid, a synthetic polymer, or a surfactant, or any combination thereof. In some embodiments, the magnetic material includes particles containing a magnetic core. In various embodiments, the magnetic material is selected from an oxide, a nitride, a metal, or a metal alloy, or a combination thereof, and can be magnetite, maghemite, Ni, Co, Fe, FePt, CoPt, FePd, or CoPd, or any combination thereof. In some embodiments, the magnetic material is in the form of a nanoparticle or a microparticle.

In the method of removing a contaminant from its environment, the environment can include contaminated water, contaminated soil, or contaminated sediment, or any combination thereof. Also, in the method, the magnetic composition can be in the form of a nanoparticle or a microparticle.

In a further aspect, a composition is provided that includes a micelle array confined in a magnetic mesoporous framework. In embodiments of the composition, micelles of the micelle array can be physically confined, chemically confined, or both physically and chemically confined, within the mesoporous framework. In some embodiments, the micelle array can include a surfactant. Embodiments of the composition can further include a grafted monolayer or a polymer brush for enabling heavy metal decontamination and organic matter removal. In addition, embodiments of the composition can include a core/shell structure, which in certain embodiments includes an iron oxide core, a silica mesoporous framework, and a cationic surfactant-containing micelle array. In some embodiments, the composition is in the form of a nanoparticle or a microparticle.

In another aspect, a method of producing a magnetic micelle array is provided. The method includes preparing a magnetic particle, and mixing a surfactant and a mesoporous framework-forming substance with the magnetic particle in such a way that surfactant micelles confined in a mesoporous framework are produced on the surface of the magnetic particle. In certain embodiments, the magnetic particle is produced by preparing a core magnetic particle and then reversing surface charges of the core magnetic particle. In some embodiments, the magnetic micelle array can be in the form of a nanoparticle or a microparticle. In various embodiments, the mesoporous framework-forming substance can be a silica-based substance. In particular embodiments, the magnetic particle can include an iron oxide, the surfactant can be a cationic surfactant, and the mesoporous framework produced on the surface of the magnetic particle can be a silica mesoporous framework.

In another aspect, a method of removing a contaminant from a liquid is provided. The method includes passing a solution of an amphiphilic compound-stabilized nanoparticle through a chromatographic column comprising silica, where the silica material is coated with a material that interacts with functional surface groups of the amphiphilic compound.

In a further aspect, a method is provided of enriching for a hydrophobic organic compound. The method includes adsorbing the hydrophobic organic compound into a micelle array confined in a magnetic mesoporous framework, and applying a magnetic field to select for the hydrophobic organic compound. As will be apparent, various embodiments of this method are similar to the embodiments disclosed herein involving the removal of a hydrophobic organic compound contaminant from its environment, except that in the enriching method, the hydrophobic organic compound is not considered as a contaminant. For example, a hydrophobic organic compound in a liquid sample can be enriched for instrumental analysis of the hydrophobic organic compound.

In another aspect, a method is provided of enriching for a composition such as single-walled carbon nanotubes, multi-walled carbon nanotubes, fullerenes, carbon black or a carbon black-type material, or boron nitride particles, or any derivative or combination thereof. The method includes adhering an amphiphilic material comprising functional surface groups to the composition, interacting a magnetic material with the functional surface groups of the amphiphilic material, and applying a magnetic field to select for the composition. As will be apparent, various embodiments of this method are similar to the embodiments disclosed herein providing for the removal of a nanoparticle contaminant from its environment, except that in the enriching method, the nanoparticle is not considered as a contaminant. For example, a fullerene-type nanoparticle in a sample can be enriched for instrumental analysis of the nanoparticle.

Mag-PCMAs and other magnetic compositions can provide a fast, convenient, and highly efficient way of removing HOCs ex situ and in situ from contaminated water, soils, sediment, and other contaminated materials. Various embodiments can be used for ambient water remediation, drinking water purification, soil and sediment remediation, sample enrichment for instrumental analysis, and other purification applications. In addition, the use of magnetic compositions to remove carbon nanotubes and related materials can be a simple and easy to use method for removal of such nanoparticles, which leaves little or no toxic residue and thus is environmentally friendly. The method should result in removal efficiencies greater than 92% via just a single pass. Various embodiments have several applications, such as: drinking water purification; ambient water remediation; nanoparticle and nanotube separation; nanoparticle and nanotube purification; soil remediation, and synthesis and processing of composite materials containing such nanoparticles.

### BRIEF DESCRIPTION OF THE DRAWINGS

For a more complete understanding of the present invention, reference is now made to the following descriptions taken in conjunction with the accompanying drawing, in which:

FIG. 1 is an illustration of a typical micelle structure;

FIG. 2 is a graph showing diuron solubility enhancement as a function of benzalkonium chloride concentration;

FIG. 3 is a diagram of HOC partitioning within a soil-water-surfactant system;

FIG. 4A and FIG. 4B are graphs for diuron with Triton X-100 and diuron with benzalkonium chloride, respectively, showing experimental results of partitioning of diuron within soil-water-surfactant systems;

FIG. 5A is a powder XRD pattern, FIG. 5B is an SEM image and FIG. 5C is a TEM image of magnetite microparticles, and FIG. 5D is an image showing the magnetic and well-dispersed behavior of magnetite microparticles, where the XRD pattern is characteristic of the magnetite phase (JCPDS 75-1609);

FIGS. 6A, 6B and 6C are a TEM micrograph of Mag-PCMA, a TEM micrograph of the mesostructure of Mag-PCMA, and an SEM micrograph of Mag-PCMA, respectively, and FIG. 6D is an image showing magnetic separation of Mag-PCMA, where the surfactant was removed by calcination for better contrast; FIG. 6E is a schematic representation of a typical Mag-PCMA synthesis, with the core and shell not drawn to scale;

FIG. 7A is a small angle X-ray diffraction pattern of Mag-PCMAs, and FIG. 7B is a thermogravimetric (TG) analyses of as-made and methanol-washed Mag-PCMAs, where the weight percentage of the surfactant confined in the Mag-PCMAs can be determined by the difference of initial and final masses of the sample;

FIG. 8 is a schematic drawing showing expansion of the mesopores of Mag-PCMAs in the presence of a micelle-swelling agent;

FIG. 9 is an image showing the stability of HA-stabilized CNTs against extraction by organic solvent, where the samples are: (A) no organic solvent; trichloroethene; (B) TCE (log₁₀(K_{ow})=2.33); (C) toluene (log₁₀(K_{ow})=2.58); (D) hexane (log₁₀(K_{ow})=4.00); and (E) octane (log₁₀(K_{ow})=5.18);

FIG. 10 is an image showing a comparison of single-walled carbon nanotube (SWCNT) affinity to water in the presence (sample B) and absence (sample C) of HA, where sample A is a HA-stabilized SWCNT blank, and the overlying phase is toluene in the samples B and C;

FIG. 11 is an image showing CNT contaminated water (sample a), water containing only HA (sample b), and CNT contaminated water after treatment (sample c);

FIG. 12A is an image showing an original multi-walled carbon nanotube (MWNT) suspension in the HA solution (MWNT: 35 mg/L and initial HA: 25 mg/L; leftmost sample), HA only (25 mg/L, middle sample), and nanoparticles separated from solution by an external magnetic field (rightmost sample); FIG. 12B and FIG. 12C are SEM images of separated Fe-NPs and Ti-NPs, respectively; FIG. 12D is a graph showing the kinetics of adsorption of HA-stabilized CNTs by Fe-NPs and Ti-NPs;

FIG. 13A is a graph showing HOC sorption isotherms, and FIG. 13B is a graph showing HOC sorption kinetics onto Mag-PCMAs;

FIG. 14 is a graph showing sorption and recovery of diuron onto Mag-PCMAs during five regeneration cycles, where % diuron removed refers to % diuron removal out of the original diuron solution of 34 mg/L while % diuron recovered refers to % diuron recovery out of the total amount of diuron sorbed by Mag-PCMAs in each case;

FIG. 15 is a graph showing cumulative % diuron recovered by Mag-PCMAs from diuron contaminated soil through three cycles;

FIG. 16A is an image of a HA-wrapped SWCNT dispersion at concentration of 53 mg/L, and FIG. 16B is an SEM image of freeze-dried cotton-like HA-wrapped SWCNTs;

FIG. 17A is an XRD pattern, FIGS. 17B and 17C are SEM images, and FIG. 17D is a TEM image, of as-prepared Fe₃O₄ nanoparticles; and

FIG. 18A is a TEM image of γ-Fe₂O₃@SiO₂@TiO₂ nanoparticles (Scale bar: 100 nm), the inset being an image of a core/shell nanoparticle powder; and FIG. 18B is an XRD pattern of γ-Fe₂O₃@SiO₂@TiO₂ nanoparticles, the inset being an image of superparamagnetic nanoparticles attracted by a magnet.

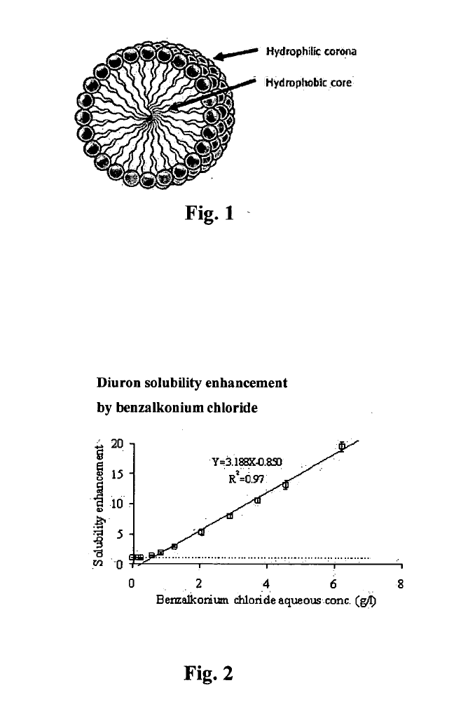

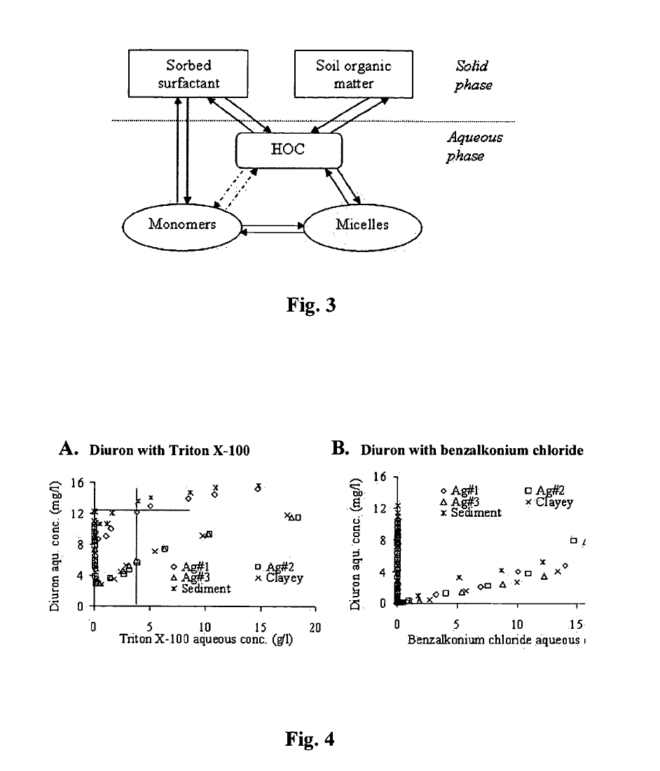

### DETAILED DESCRIPTION

In various embodiments, a contaminant is removed from its environment. In some embodiments, the contaminant is dissolved in its environment, while in other embodiments, a contaminant is not dissolved but is in a particulate form such as a nanoparticle. In certain embodiments, the contaminant is present in both a dissolved form and a particulate form in its environment. In general terms, a contaminant is a chemical substance harmful or potentially harmful to the ecology. Examples of contaminants include, but are not limited to, volatile organic compounds, semi-volatile organic compounds, acid extractable compounds, phenolic compounds, base neutral compounds, polycyclic aromatic hydrocarbons, polychlorinated biphenyls, pesticides, insecticides, herbicides, metals, and radionuclides. The term “environment” refers to the chemical and/or physical surroundings of a contaminant. For example, depending on the context, “environment” can refer to soil, earth, sediment, or a body of water, or can refer to a liquid or solvent, or a chemical mixture such as a solution or a colloid. In any embodiment involving removal of a contaminant, the contaminant can be discarded after removal from the environment.

As used herein, the term “nanoparticle” refers to a particle having at least one dimension that is less than or equal to 500 nanometers. In particular embodiments, this dimension can be in the range of at or about 1 nanometer to at or about 400 nanometers, at or about 1 nanometer to at or about 300 nanometers, at or about 1 nanometer to at or about 200 nanometers, or at or about 1 nanometer to at or about 100. A carbon nanotube having a width or diameter of a few nanometers is therefore considered a nanoparticle herein even though its length can be greater than 500 nanometers. A microparticle is a particle having dimensions that are between 0.5 and 100 micrometers. The nanoparticle or microparticle can be any shape such as spheroid, cuboid or linear. In some embodiments, the nanoparticle or microparticle has a spheroidal shape. As used herein, the term “shell” refers to the surface layer of a nanoparticle or microparticle. A nanoparticle or microparticle comprising a shell and including a core that contains solids is referred to as a core-shell nanoparticle or microparticle. In different embodiments, a core can be completely or partially filled with solids.

A magnetic field can be generated in ways well know in the art, such as by a magnet, electromagnet or alternating currents.

### Magnetic Micelle Arrays

Some embodiments provide hydrophobic organic compounds and micelle arrays confined in a magnetic mesoporous framework. Examples of HOCs include, but are not limited to, hydrophobic pesticides, polycyclic aromatic hydrocarbons, and polychlorinated biphenyls. As used herein, “hydrophobic” refers to a compound or a part of a compound that can interact with the lipophilic portion of an amphiphilic substance. The term “mesoporous framework” refers to a structure having an average pore diameter in the range of at or about 0.1 nanometers to at or about 100 nanometers. In certain embodiments, the average pore diameter ranges from at or about 2 nanometers to at or about 50 nanometers.

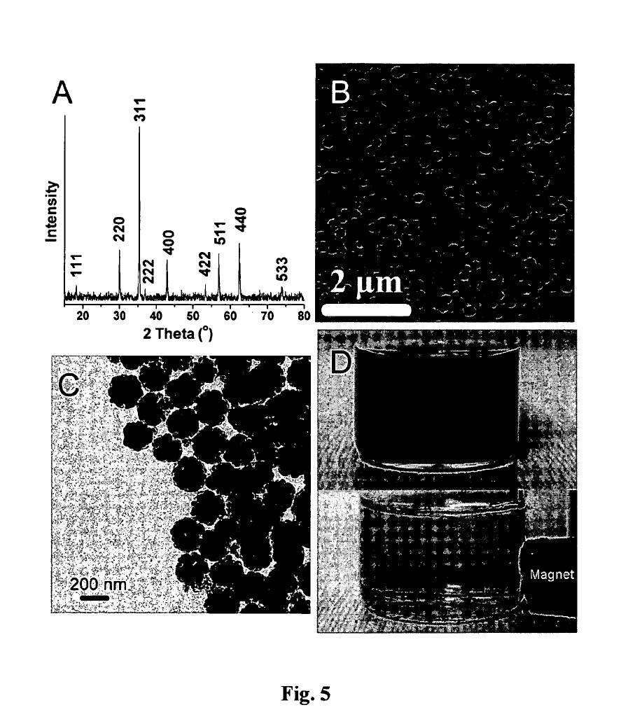

In various embodiments, micelle arrays confined in a magnetic mesorporous framework can be designed to address the challenges associated with conventional surfactant-aided soil washing techniques. For example, certain compositions designated “Mag-PCMAs” contain solidified micelle arrays with a magnetic core, in this case made of magnetite, as shown in FIG. 5A. The Mag-PCMAs can be prepared for HOC removal. Cooperative assembly of a surfactant and a mesoporous framework-forming substance, in this case silica precursors, solidifies micelle arrays in the mesostructured silica framework, [17] leading to the confinement of large amounts of surfactant micelles in a small volume. For example, the surfactant 3-(trimethoxysily)propyl-octadecyldimethyl-ammonium chloride (TPODAC) with a reactive endgroup —Si(OCH₃)₃ on its hydrophilic groups, can be used to form surfactant micelles that permanently anchor on the silica framework through covalent bonding. This unique structural property avoids surfactant loss during application and allows for sorbent regeneration. The superparamagnetic core provides rapid separation of sorbents after HOC sorption. Mag-PCMAs can provide a rapidly and efficiently solution to remove HOCs from environmental media.

As an example of preparing micelle arrays confined in a magnetic mesorporous framework, a typical synthesis of Mag-PCMAs has the following steps. First, superparamagnetic nano- or microparticles, such as Fe₃O₄, can be prepared via a solvothermal method as described previously [12]. FIG. 5A shows a powder X-ray diffraction (XRD) pattern, FIG. 5B a scanning electron microscopy (SEM) micrograph, and FIG. 5C a transmission electron microscopy (TEM) micrograph of Fe₃O₄ microparticles, as an example of the types of superparamagnetic materials that can be employed. The superparamagnetic microparticles in a homogeneous dispersion exhibit fast response to an applied magnetic field (FIG. 5D) and redisperse quickly with a slight shake once the magnetic field is removed. This indicates excellent magnetic responsivity and redispersibility, which is a great advantage in contaminant treatment applications. An intermediate, thin, nonporous layer (such as a silica layer) can be selectively coated between magnetic cores and mesoporous silica layers, depending on the applications.

The superparamagnetic particles can be treated to make the particle surface opposite in charge to the non-treated surface. For example, a positively charged particle surface can be made negatively charged using tetramethylammonium hydroxide (TMAOH). The charged negative surface allows for co-assembly of the surfactant micelles (e.g. TPODAC) and the mesoporous framework-forming species (in this case, silica) on the particle surface and therefore provides direct deposition of the ordered mesostructured surfactant/silica hybrid layer, avoiding an intermediate non-porous silica coating on the superparamagnetic particles [18].

Coating of a layer of silica/TPODAC mesostructured hybrid layer on the negatively charged Fe₃O₄ microparticles creates a core/shell structure. TPODAC, a commercially available quaternary ammonium type cationic surfactant, can act as a structure-direct agent in forming ordered mesostructured hybrid material via cooperative assembly with silica precursors under basic conditions, similar with other quaternary ammonium type cationic surfactants such as cetyltrimethylammonium bromide (CTAB) [17]. Cooperative assembly of surfactant and silica precursors solidifies micelle arrays in the mesostructured silica framework [17], leading to the confinement of large amounts of surfactant micelles in a small volume. The surfactant, TPODAC, has reactive endgroups —Si(OCH₃)₃ on its hydrophilic groups, which allows the surfactant micelles to permanently anchor on the silica framework through covalent bonding. Silica provides a solid framework to condense and support surfactant micelles in a high density manner. The framework is not limited to silica; examples of other inorganic components in any particular embodiment include, but are not limited to, titanium oxide, zirconium oxide, tin oxide and cerium oxide, but silica is an inexpensive material and its co-assembly with surfactant molecules to create ordered mesostructured hybrids has been well-documented.

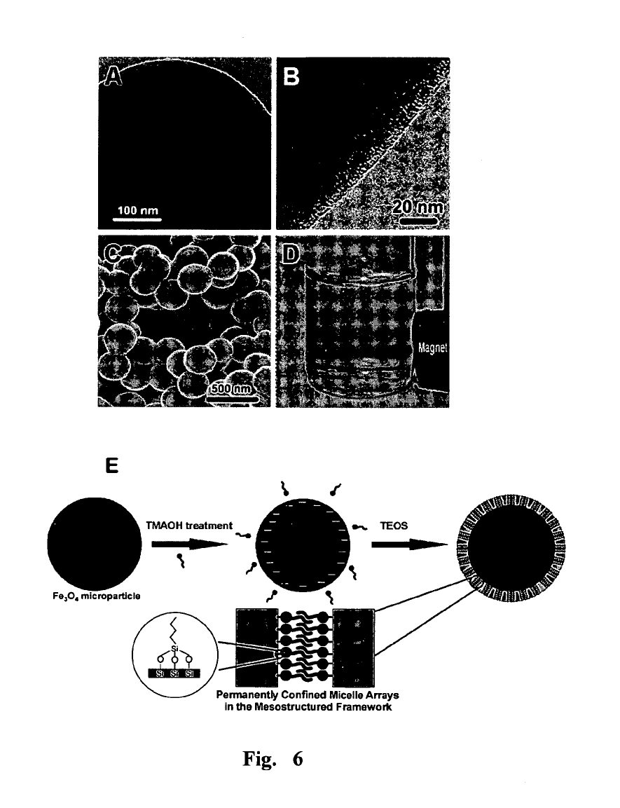

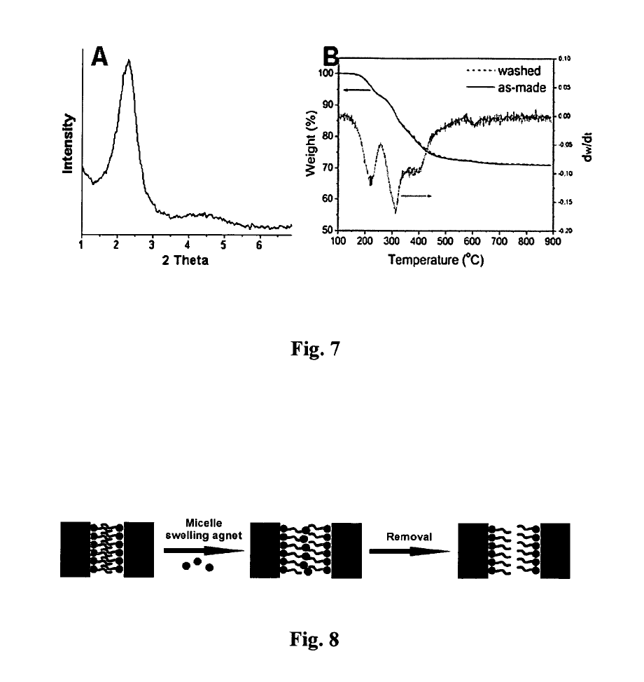

The core/shell structure of a Mag-PCMA is shown in FIG. 6A and the ordered mesostructure of the shell is demonstrated by the transmission electron microscopy (TEM) micrograph in FIG. 6B. An SEM micrograph of a Mag-PCMA is shown in FIG. 6C, and magnetic separation of Mag-PCMAs is shown in FIG. 6D. A schematic representation of the overall synthesis of magnetic micelle arrays is shown in FIG. 6E. A small angle X-ray diffraction pattern of the particles is shown in FIG. 7A.

Examples of surfactants for any particular embodiment include, but are not limited to, non-ionic surfactants such as polyoxyethylene fatty acid ester, polyoxyethylene hardened castor oil, polyoxyethylene sorbitan fatty acid ester, glycerol fatty acid ester, polyoxyethylene alkyl ether and polyoxyethylene polyoxypropylene glycol; anionic surfactants such as soaps, sulfonates such as alkyl glyceryl ether sulfonates, ethoxylated or not, sodium cocoyl isethionate, sodium cocoylmonoglyceryl sulfonate, sodium lauryl sulfate, ethoxylated or not, the short chain alkyl substituted aromatic, particularly sodium cumene sulfonate, ethoxylated or not, sodium dodecylbenzene sulfonate; and cationic surfactants such as monoalkyl quaternary ammonium salt cationic surfactants like stearyltrimethylammonium chloride, myristylmethylammonium chloride, and palmityldimethylethylammoniumethyl sulfate, or ethylene oxide addition quaternary ammonium salt cationic surfactants like dipolyoxyethylene (2 mol addition) stearylethylammonium bromide and dipolyoxyethylene (4 mol addition) behenylmethylammonium chloride.

Magnetic materials that can be used to prepare magnetic particles include, but are not limited to, ferromagnetic materials and superparamagnetic materials, particularly iron oxides (such as magnetite, maghemite), metals (such as Ni, Co, Fe), alloys (such as FePt, CoPt, FePd, CoPd, and other magnetic oxides and nitrides.

Examples of compounds for reversing surface charges of nanoparticles include tetramethylammonium hydroxide and other quaternary ammonium hydroxides.

The fraction of surfactant micelles confined within an ordered framework such as a silica framework can be determined by thermogravimetric (TG) analysis. For example, TG analysis indicated the fraction of surfactant micelles was approximately 30% of the total mass of Mag-PCMAs (FIG. 7B). The high fraction of micelles and ordered mesostructure lead to a large, connecting hydrophobic environment with high affinity towards HOCs.

One key aspect is the ability to regenerate and reuse the magnetic micelle arrays using solvents to extract the HOCs without affecting the stability of the magnetic particles. For example, TG analysis of original, and methanol washed Mag-PCMAs (FIG. 7B) shows that the solvent extraction did not remove any significant amount of TPODAC from the mesostructured silica framework.

In addition, the framework size and morphology of micelle arrays confined in a magnetic mesorporous framework, including Mag-PCMAs, can be further tuned to optimize treatment efficiency and magnetic micelle arrays such as Mag-PCMAs may be applicable to relatively water-soluble or volatile organic compounds, with appropriate tailoring of the surfactant properties.

Furthermore, end-functionalized organic small molecules (e.g., hydrophobic alkyl chains) or polymer chains may be grafted or conjugated to the surface of the mesoporous framework as monolayers or polymer brushes, which may have high affinity to HOCs, heavy metals, or natural organic matter (NOM). Examples of such organic small molecules and polymer chains include, but are not limited to, trimethylsilyl chloride, polyethylene glycol, polystyrene. These magnetic micelle arrays therefore enable removal of HOCs, heavy metals, and NOM from water, soils, sediments and other contaminated media. Multiple functionalization can be carried out and provide switching and adaptive surface properties.

Micelle-swelling agents, such as trimethyl benzene, can be used to expand the mesopores of magnetic micelle arrays such as Mag-PCMAs. As shown in FIG. 8, the expanded mesopores should allow for higher HOC sorption capacities. Other micelle-swelling agents include, but are not limited to, triisopropyl benzene, decane, and aliphatic amines.

Particles containing micelle arrays confined in a magnetic mesorporous framework, and having an internal cavity can also be synthesized. For example, Mag-PCMAs having a mesoporous shell with the same composition and size and a smaller magnetic core can be synthesized, resulting in internal cavity within Mag-PCMAs. Magnetic micelle arrays such as Mag-PCMAs with internal cavity have high potential for HOC decontamination.

In addition to the layer-by-layer growth approach as reported previously, core/shell structures of micelle arrays confined in a magnetic mesorporous framework, such as Mag-PCMAs, can also be created by a one-step spray drying methodology.

Some advantages of embodiments involving magnetic micelle arrays are:
(1) Mag-PCMAs confine surfactant micelles via chemical bonding and thus eliminate surfactant loss, resulting in significant increase in the treatment efficiency of HOC decontamination;
(2) Mag-PCMAs can be easily separated by applying an external magnetic field, significantly reducing the operation cost;
(3) Mag-PCMAs can be regenerated with organic solvents and reused for several cycles without significant loss in HOC sorption capacity;
(4) The final product of decontamination using Mag-PCMAs treatment is a small amount of HOC-loaded organic solvent.
(5) The composition of the Mag-MCMAs can be tuned depending on the application. Mag-MCMAs, as well as other micelle arrays confined in a magnetic mesorporous framework, can be used for ex situ and in situ remediation of HOC-contaminated soils and sediment; ambient water remediation; drinking water purification; sample enrichment for instrumental analysis (HPLC, GC, and the like).

Other advantages include:
(1) Surfactant micelles are confined within a mesoporous solid framework with a magnetic core, which eliminates the release and subsequent sorption of surfactant onto soil, sediment or other solid media. The methods and compositions may be applicable even to relatively water-soluble or volatile organic compounds, with appropriate tailoring of the surfactant properties.
(2) After sorbing the HOCs onto the Mag-PCMAs, the magnetic-responsive Mag-PCMAs can be removed from aqueous solution by applying a magnetic field. Therefore, the contaminated soil and sediment can be cleaned up to a very high level with no significant amount of contaminant-containing water to be treated or an energy-intensive size separation processes involved in conventional surfactant-aided soil washing; the cleaned soils and sediments may be suitable for placing them back in the environment;
(3) HOCs can be removed from the Mag-MCMAs by washing the HOC-loaded Mag-PCMAs with a small amount of a suitable organic solvent (e.g. methanol, toluene, acetone, and the like).
(4) Mag-PCMAs can be regenerated several times and reused without significant loss of sorption capacity, leading to much reduced operation costs;
(5) The composition of the Mag-PCMAs can be tuned depending on the application. In most cases, a silica framework is used because soil and sediment particles have negative charges on their surfaces. The surface charges of the silica are negative and are less pH-dependent than other metal oxide particles. In this case, Mag-PCMAs will not sorb onto the soil, sediment or other solid media to a significant extent, and thus the loss of Mag-PCMAs is expected to be small and thus high recovery of HOC-loaded Mag-PCMAs after the treatment is completed can be expected. Also, the performance of the Mag-MCMAs will not be dependent on soil and sediment pH and ionic strength. Thus, Mag-MCMAs provide a versatile means of remediating HOC contaminated soils and sediments under various conditions.

### Fullerene and Related Materials

Other embodiments provide a method to remove dispersed nanoparticles from aqueous solutions and other environments. The method utilizes the interaction of magnetic materials with functional surface groups of amphiphilic compounds that are in turn adhered to a wide range of hydrophobic nanoparticles. As used herein, the term “amphiphilic compound” refers to a compound having both hydrophilic and hydrophobic (or lipophilic) properties. Amphiphilic compounds are exemplified by natural organic matter (NOM), humic acid (HA), and related synthetic polymers (e.g., nonionic polyacrylamide, polyoxyethylene isooctylphenyl ether, polyvinyl pyrrolidone, anionic polycarylic acid, polystyrene sulfonate, cationic primary, secondary, tertiary and quaternary polyamines; natural polymers such as starch, chitosan, or DNA), and surfactants (e.g., sodium dodecylbenzene sulfonate, dodecyltrimethylammonium bromide, Triton X-100). A functional surface group of an amphiphilic compound is a functional group, such as a carboxylate or hydroxyl group, that interacts with a magnetic material.

Nanoparticles to which the amphiphilic compound can be adhered include, but are not limited to, single-walled and multi-walled carbon nanotubes and their derivatives, fullerenes and their derivatives, carbon black and similar compounds (e.g. soot, lampblack) and their derivatives, and boron nitride particles (including rods and spheres) and their derivatives. Magnetic materials include, but are not limited to, ferromagnetic materials and superparamagnetic materials, including iron oxides (such as magnetite, maghemite), metals (such as Ni, Co, Fe), alloys (such as FePt, CoPt, FePd, CoPd) and other magnetic oxides and nitrides.

The response of the magnetic nanomaterials to a magnetic field allows for removal of the target nanoparticles from an aqueous solution. This technology is superior to existing ultra- or nanomembrane filtration, since it avoids the potential for clogging (fouling) of the membrane typically seen in these systems, particularly in the presence of natural organic matter. It is also superior to approaches which rely on changes in pH or ionic strength of the solution, which are generally impractical for large-scale water treatment, and which may only result in temporary removal since precipitated nanoparticles might resuspend.

In another embodiment, materials that can form strong interactions with the functional surface groups of amphiphilic compounds can be coated onto chromatographic silica to make affinity chromatographic columns for separation of, for example, humic-acid-stabilized carbon nanotubes according to their sizes and structure. The separation principle is based on the affinity between the coated materials and amphiphilic compound-stabilized hydrophobic nanoparticles and nanotubes but in this case there is no need to apply magnetic property on the particles to separate them. This embodiment provides an economical and scalable way to separate carbon nanotubes and other nanoparticles.

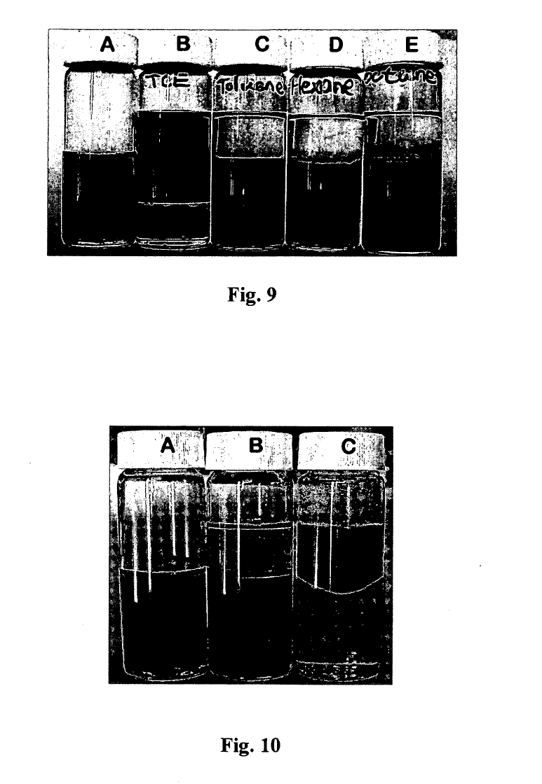

Although it is possible to reduce system pH to the point of zero charge (PZC) of the humic acid-stabilized CNTs or increase the ionic strength to destabilize the humic acid-stabilized CNTs and cause them to precipitate, these measures may have significantly adverse ecological effects. More importantly, the CNT removal would be temporary in that as environmental conditions change, the precipitated CNTs might re-suspend, imposing risk again. In addition, as shown in FIG. 9 and FIG. 10, humic acid-stabilized CNTs can be very stable against organic solvent extraction for a wide range of solvents (octanol-water partitioning coefficient, K_{ow}, from 10^{2.33} to 10^{5.18}), indicating a significant increase in hydrophilicity of the CNT surface when stabilized with humic acid. Moreover, due to their smaller diameters, CNTs can easily penetrate through most commercial filter membranes without being filtered.

Affinity-based strategies have been widely used to enrich and separate target molecules with low concentration in the bulk solutions because of their high efficiency and specificity, such as enrichment of phosphorylated peptides from the proteolytic peptide mixtures by immobilized metal affinity chromatography (IMAC) [19,20] or metal oxide superparamagnetic nanoparticles [21], and removal of heavy metals from contaminated water by thiol functionalized superparamagnetic nanoparticles [22]. Since humic acid has abundant hydrophilic functional groups, such as carboxylic acid, phenolic hydroxyl, and aliphatic hydroxyl, transition metal oxides (iron oxide, titania, zirconia, and the like) can be used as adsorbents because of their strong interaction with these hydrophilic functional groups, especially the carboxylic groups. For example, the affinity between carboxylic groups and magnetite nanoparticles has been demonstrated by adsorption of acidic peptides on magnetite nanoparticles [21] and thiol functionalization of magnetite nanoparticles by dimercaptosuccinic acid [22, 23]. It is either a hydrogen bonding interaction through —OH group (under acidic conditions) or a direct Fe-carboxylate linkage (at more alkaline pH values in this study) [24].

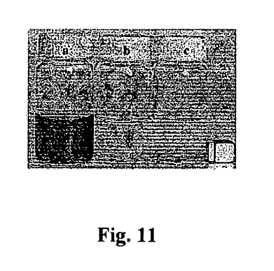

As an example of the removal of nanoparticle contaminants, in FIG. 11, sample (a) shows CNT contaminated water, sample (b) shows water containing only humic acid, and sample (c) shows CNT contaminated water after treatment. Removal efficiencies of the nanoparticles of more than 92% are achievable. The methodology may also be useful in the preparation and processing of composite materials that utilize the nanoparticles described herein.

The magnetic removal can result in a permanent removal of nanoparticles from water. This technology is applicable to contaminant nanoparticles with amphiphilic coatings whose functional groups can interact with magnetic materials, such as magnetic nanoparticles or microparticles, through electrostatic interaction, coordination bonding, pi-pi bonding, as well as other known interactions.

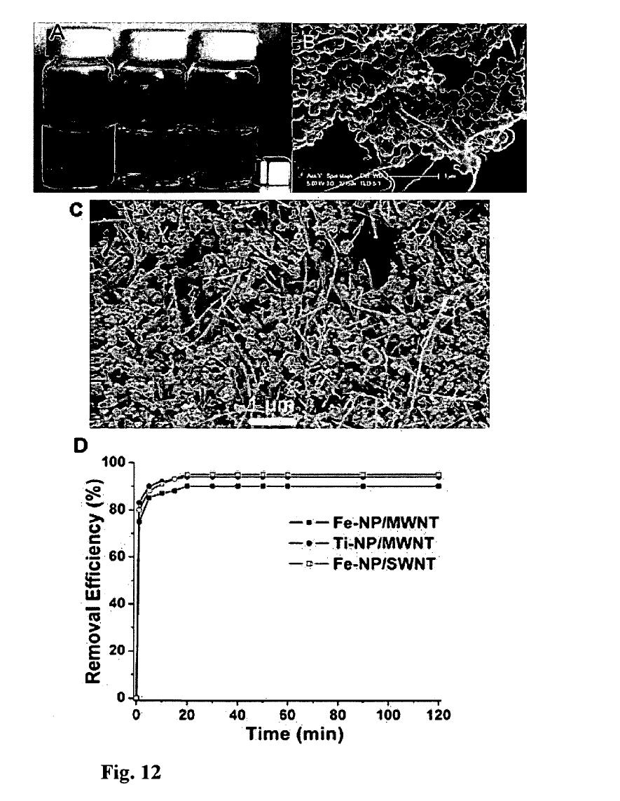

As an example of removing a substance from its environment, magnetic materials, which in this case were magnetite (Fe₃O₄) nanoparticles of about 200 nm in diameter or γ-Fe₂O₃@SiO₂@TiO₂ core/shell superparamagnetic nanoparticles of about 80 nm in diameter, were prepared for removing humic acid-stabilized carbon nanotubes from an aqueous solution environment, and for investigating adsorption kinetics. The magnetite nanoparticles were synthesized according to Deng et al.'s report [23], and the core/shell nanoparticles were synthesized by a sol-gel-based coating strategy of titania on γ-Fe₂O₃@SiO₂ nanoparticles. FIG. 12A shows that the potential contaminant, solubilized humic acid-stabilized nanotubes, were adsorbed and enriched by the magnetite nanoparticles and separated from solution by a magnet. Separated magnetite nanoparticles and core/shell nanoparticles were investigated by scanning electron microscopy (SEM), which showed that nanotubes were adsorbed and enriched on the surface of these adsorbents (FIGS. 12B and 12C, respectively). Adsorption kinetics of humic acid-stabilized carbon nanotubes by the magnetite nanoparticles and the core/shell nanoparticles were studied and shown in FIG. 12D. It can be seen that the rate of carbon nanotube uptake was initially quite high, followed by a much slower subsequent removal rate leading gradually to an equilibrium condition. About 88% of single-walled nanotubes and 85% of the multi-walled nanotubes were removed during the 5 minutes of the reaction by the magnetite nanoparticles, respectively, while only a very small part of the additional removal occurred during the following 15 minutes of contact. In the experiments of FIG. 12, the amount of nanoparticles used to adsorb carbon nanotubes is 0.1 g and the concentration of humic acid-stabilized carbon nanotube solutions is 35 mg/L. Nanoparticles, including single-walled carbon nanotubes of 1.5 nanometer average diameter, and multi-walled carbon nanotubes of 35 nanometer average diameter, can be removed by this procedure.

The rapid adsorption of a contaminating substance is advantageous for a removal strategy and perhaps attributed to the external surface adsorption. At equilibrium, the removal efficiency of single-walled nanotubes and multi-walled nanotubes at initial concentration was found to be 95% and 90%, respectively. The core/shell nanoparticles showed a bit higher removal efficiency of carbon nanotubes than magnetite nanoparticles, in which 90% of multi-walled nanotubes was removed in the first 5 minutes and the removal efficiency at equilibrium was found to be 94%. The increased removal efficiency can be attributed to higher surface area resulting from smaller particle size. Clearly, using affinity nanoparticles provides a permanent and rapid removal strategy of humic acid-stabilized carbon nanotubes from the aqueous solution.

This novel approach provides embodiments in which nanoparticles partially coated with amphiphilic compounds can be easily removed from a liquid by adding magnetic nanoparticles or similar nanoparticles containing a magnetic core, directly into the liquid, mixing the liquid to form an association between magnetic nanoparticles and nanoparticles coated with amphiphilic compounds, such as NOM and humic acid, and subsequently removing the associated substances by applying a magnetic field.

The present invention may be better understood by referring to the accompanying examples, which are intended for illustration purposes only and should not in any sense be construed as limiting the scope of the invention as defined in the claims appended hereto.

### Example 1

Examples 1-8 concern magnetic micelle arrays.

Chemicals. Atrazine (2-chloro-4-ethylamino-6-isopropylamino-1,3,5-triazine) was purchased from Supelco Inc. (Bellefonte, Pa., USA); diuron (3-(3,4-dichlorofenyl)-1,1-dimethylurea) was purchased from ChemService Inc. (West Chestnut, Pa., USA); biphenyl and naphthalene were purchased from ACROS (Geel, Belgium); tetraethyl orthosilicate (TEOS), [3-(trimethoxysily)propyl]-octadecyldimethysmmonium chloride (TPODAC) (72 wt. % in methanol), a cationic surfactant, and tetramethylammonium hydroxide (TMAOH) (25 wt. % in water) were purchased from Sigma-Aldrich (San Louis, Mo., USA). All these chemicals were used as received. Humic acid (HA), a representative of natural organic mater, was purchased from Sigma-Aldrich

Synthesis of Fe₃O₄ particles. The core magnetite particles were prepared through a solvothermal reaction according to a previous report [18]. Briefly, 2.70 g of FeCl₂.6H₂O and 7.20 g of sodium acetate were dissolved in 160 ml of ethylene glycol. The obtained homogeneous solution was solvothermally heated at 200° C. for 8 h. The obtained black particles were washed with ethanol and water for 6 times, and then dried at 60° C. for 12 h.

Synthesis of Fe₃O₄@SiO₂-TPODAC core/shell structured particles. The core-shell structured Fe₃O₄@SiO₂-TPODAC particles were prepared by means of cooperative assembly of silica oligomers and TPODAC on the Fe₃O₄ microparticles. Briefly, 0.10 g of Fe₃O₄ microparticles were treated with 40 ml TMAOH solution overnight. The TMAOH-treated Fe₃O₄ microparticles were washed thoroughly with ethanol and then dispersed in a mixture of 60 ml ethanol and 10 ml deionized (DI) water. During mechanical stirring, 0.24 ml of TPODAC (72 wt. %) was added, followed by the addition of 1.0 ml of aqueous ammonia solution (25 wt. %) and 0.22 ml of TEOS. After stirring at room temperature for 6 h, the Fe₃O₄@SiO₂-TPODAC particles were washed with ethanol thoroughly, dried at 60° C. for 12 h, and stored in a capped bottle prior to use. In these examples, Fe₃O₄@SiO₂-TPODAC core/shell structured particles are described as Mag-PCMAs to indicate both their structure and composition.

Material Characterization. Powder X-ray diffraction (XRD) patterns were collected on a Scintag PADX diffractometer with Ni-filtered Cu K α radiation (45 kV, 35 mA). Transmission electron microscopy (TEM) images were obtained using a JEOL 2010 microscope operated at 200 kV. Scanning electron microscopy (SEM) studies were performed on an FEI XL40 Sirion FEG microscope equipped with an Oxford EDX analysis system. Organic solvent extraction and thermogravity measurement were used to investigate the strength of bonding between the surfactant and the solid framework. Typically, 0.1 g of Mag-PCMAs were treated with 50 ml of methanol by stirring for 4 h. Mag-PCMAs were then collected and thermogravimetric (TG) analyses were carried out on a Mettler Toledo TGA/sDTA851e apparatus under an air flow of 100 mL/min with a heating rate of 10° C./min.

Sorption kinetics of HOCs onto Mag-PCMAs from contaminated water. The HOC sorption kinetics onto Mag-PCMAs were determined by batch experiments. Aliquots (50 mg) of Mag-PCMAs were mixed in 10 ml glass tubes with 10.0 ml of an aqueous solution of each HOC. The initial HOC concentrations were 25.5 μmol/L for atrazine, 25.8 μmol/L for diuron, 46.9 μmol/L for naphthalene, and 39.0 μmol/L for biphenyl. The caps of the tubes were lined with PTFE. The tubes were shaken at 60 rpm at 22±2° C. continuously. At the end of 5, 10, 20, 30, 45, 60, 90, 120, 180, 200, 360, 720, and 1440 minutes, one tube was taken out. A magnet was then used to separate the Mag-PCMAs from the aqueous phase. Preliminary results showed that the sorption of HOCs onto the glass tubes was insignificant. 1.0 ml of the supernatant was taken for HOC analysis on a high performance liquid chromatography (HPLC). The amount of HOC sorbed was calculated as the difference between the initial and final HOC mass in aqueous phase. To order to investigate the effect of the presence of HA on HOC sorption kinetics, diuron sorption kinetics were determined in the presence of 20 mg/L HA (organic carbon content), an environmental relevant HA concentration.²⁹ The initial diuron concentration was 34.3 μmol/L.

Sorption isotherms of HOCs onto Mag-PCMAs from contaminated water. The sorption isotherms of the HOCs onto Mag-PCMAs were determined by the same procedure as the sorption kinetics determination except that the initial HOC concentration spanned over a large range and the equilibration time was 240 min (4 h) uniformly, which was determined to be more than enough for HOC sorption equilibrium to be reached. The highest initial HOC concentrations used for the sorption experiments were 125 μmol/L for atrazine, 137 μmol/L for diuron, 218 μmol/L for naphthalene, and 39 μmol/L for biphenyl, each of which is close to the water solubility of each HOC respectively. The pH of the suspensions was stable between 6˜7 and did not show significant change before or after sorption. All measurements were carried out at room temperature (22±2° C.).

The HOC sorption experiments were also conducted in the presence of 20 mg/L HA to investigate the effect of natural organic matter on HOC sorption onto Mag-PCMAs. Only the highest initial HOC concentrations were used in these cases. The equilibrium aqueous HA concentration was measured on a total organic carbon analyzer (Shimadzu).

Regeneration and reuse of Mag-PCMAs. Diuron was chosen to study the recovery of the sorbed HOCs from Mag-PCMAs and regeneration of Mag-PCMAs. The same sorption experiment was conducted first, followed by separating the Mag-PCMAs solid by magnetic separation. Diuron was then extracted with methanol from the collected Mag-PCMAs. The diuron concentration in the extracted solution was determined by HPLC. Only the highest diuron initial concentration (137 μmol/L) was used in this case. The regenerated Mag-PCMAs were then reused for subsequent diuron sorption experiments again. The sorption, extraction, and reuse processes were repeated for five times.

Application of Mag-PCMAs for soil treatment. A soil was collected at Santa Barbara, Calif. The soil was contaminated with diuron in the lab. The contamination involved treating 2.0 g of the soil with 10 mL of 137 μmol/L diuron solution to reach sorption equilibrium, separating the solid phase via centrifugation, decanting and replacing the supernatant with DI water. The aqueous diuron concentration in the supernatant was determined and the amount of diuron sorbed onto the soil was calculated as the difference between the initial and final mass of diuron present in the aqueous phase. A total of 50 mg of Mag-PCMAs were then added to the above-prepared contaminated-soil and water system and the whole mixture was mixed for 2 hrs to reach equilibrium, followed by magnetic separation of Mag-PCMAs out of the soil-water system. The methanol extraction was then conducted with the separated Mag-PCMAs, followed by determination of the diuron concentration in the methanol extraction solution. The Mag-PCMAs were then reused for a second and a third time in the same soil-water system following the same procedure.

HPLC analysis. A Shimadzu HPLC system was equipped with two LC-10AT VP pumps, a Sil-10AF autosampler, a DGU-14A degasser, and a SPD-M10AVP diode array detector. A Premiere C18 5μ reverse phase column was used with a length of 250 mm and an inner diameter of 4.6 mm. The HPLC analyses were carried out using an isocratic mode with a mobile phase constituted by 90% acetonitrile/10% deionized water. The analyses were performed at a constant flow rate of 1.0 ml/min. The UV detector monitored the absorbance at 222 nm for atrazine, 247 nm for diuron, 196 nm for biphenyl, and 219 nm for naphthalene. An injection volume of 20 μl was used in all cases. Calibration was conducted daily and the R² was greater than 0.98 in all cases.

### Example 2

Fe₃O₄ particles prepared as in Example 1 had a mean diameter of ˜200 nm based on the size measurement of 100 particles and are the aggregates of ˜15 nm nanoparticles, leading to the superparamagnetic behavior of the particles. Powder XRD pattern, SEM, and TEM micrographs of Fe₃O₄ particles are shown in FIGS. 5A-5C.

The prepared Fe₃O₄ particles were treated with TMAOH to make the particle surface negatively charged. TMAOH treatment reverses the surface charges of Fe₃O₄ particles from positive (ζ-potential=18.0 mV at pH=7) to strongly negative (ζ-potential=−46.3 mV at pH=7), which can be an important step in the synthesis. The negatively charged Fe₃O₄ surface allows for co-assembly of the cationic surfactant, TPODAC, and silica species on the particle surface and therefore direct deposition of the ordered mesostructured surfactant/silica hybrid layer in the later step, avoiding an intermediate non-porous silica coating on the Fe₃O₄ particles [18,25]. The highly negatively charged Fe₃O₄ surface also minimizes particle aggregation during the mesostructured layer coating process because of electrostatic repulsion.

The core/shell structure of a prepared Mag-PCMA is shown in FIGS. 6A-6C. The ordered mesostructure of the shell is demonstrated by TEM micrographs (FIGS. 6A and 6B). The mesostructured layer is approximately 100 nm as determined by TEM (FIG. 6A) and by SEM (FIG. 6C). Owing to the magnetic Fe₃O₄ cores, the synthesized Mag-PCMAs show a fast response to an applied magnetic field (FIG. 6D).

### Example 3

FIGS. 7A and 7B present the small angle XRD pattern and thermogravimetric (TG) curves, respectively, of prepared Mag-PCMAs. One intensity diffraction peak at a 2 theta value of 2.2° and a broad peak at 4-5° can be found in its small-angle XRD pattern, indicating the formation of ordered mesostructure. As demonstrated in its TEM image (FIG. 6B), although the mesostructure is not highly ordered, it shows uniform meso-scale structure due to the formation of micelles with similar diameter and uniform silica wall thickness. These results indicate that a silica confined micelles array layer was successfully coated on the magnetic core surface.

### Example 4

The TG curves of prepared Mag-PCMAs (FIG. 7B) show three weight loss steps at about 220, 310 and 600° C., as demonstrated in its derivative curve, which can be ascribed to the decomposition of quaternary ammonium group, the decomposition and carbonization of alkyl chain, and the burn off of carbon, respectively. The weight percentage of the surfactant confined within the ordered silica framework of Mag-PCMAs can be determined by the difference of initial and final mass of the sample in TG curve in FIG. 7B and was measured to be approximately 30% of the total mass of Mag-PCMAs. The high fraction of micelles and ordered mesostructure lead to a large, connecting hydrophobic environment with high affinity towards HOCs. The TG curves of as-made and methanol-washed Mag-PCMAs do not show any significant difference, indicating that essentially no surfactant was removed during methanol treatment and therefore that the surfactant is chemically confined in the silica framework. Thus, the unique structural configuration of the Mag-PCMAs avoids surfactant loss during application and sorbent regeneration.

### Example 5

Sorption isotherms and kinetics of HOCs from contaminated water. The sorption of four environmentally representative HOCs (atrazine, diuron, naphthalene, biphenyl) onto Mag-PCMAs was determined by the batch equilibration method. The sorption isotherm can usually be mathematically described by either a linear, Freundlich, or Langmuir sorption model [26]. In this study, the sorption data were best fitted by the Freundlich sorption model based on a sum of least squares analysis. The Freundlich model has the following form:

Cₛ=K_{f}Cₑⁿ (Equation 1)

where Cₛ is the sorbed HOC concentration (μmol/g), Cₑ is the equilibrium aqueous HOC concentration (μmol/L), and K_{f} (μmol/g)(μmol/L)⁻ⁿ and n (dimensionless) are constants at a given temperature. K_{f} is the HOC sorption capacity evaluated at Cₑ=1 μmol/L.

Eq. (1) can be linearized by a logarithmic transformation:

log Cₛ=log K_{f}+n log Cₑ (Equation 2)

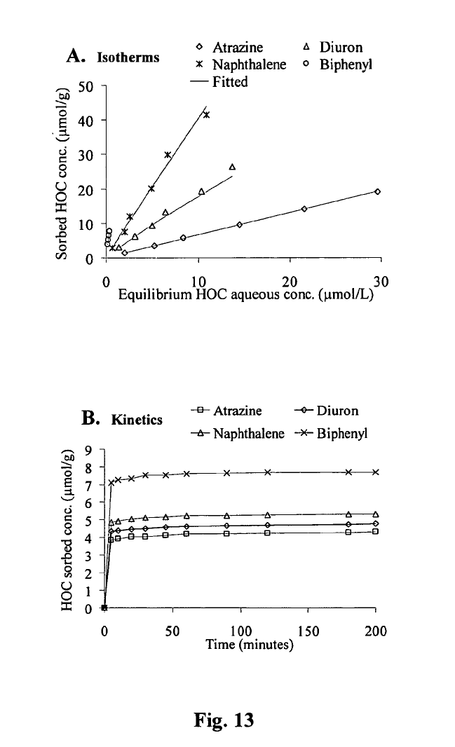

Fitting Eq. (2) to the observed data for HOCs resulted in a linear relationship with R² greater than 0.97. Freundlich parameters for sorption (K_{f} and n) were calculated from the slope and intercept of the linear regression and are listed in Table 1. FIG. 13A presents the measured HOC sorption isotherms along with the Freundlich fitted isotherms. Also presented in Table 1 are the octanol-water coefficients (K_{ow}) of the HOCs, a commonly used indicator for chemical hydrophobicity [26-28] and the removal percentage (%) of the HOCs. As can be seen, K_{f} is strongly correlated with K_{ow}, as expected from the hydrophobic interactions.

The % removal of HOCs is found to increase with hydrophobicity of the HOCs, as indicated by the increasing K_{ow}, value. It is worth mentioning that under these conditions, the % removal of naphthalene is 95% and that of biphenyl is 99%. Essentially complete removal can be expected under the same conditions for HOCs more hydrophobic than biphenyl.

TABLE 1
Measured HOC sorption parameters by Mag-PCMAs

| | Solubility | | | | % | % |
|---|---|---|---|---|---|---|
| HOC | (mg/L) | K_{ow} | K_{f} | N | removal^{a} | removal^{b} |
| Atrazine | 153 | 416 | 0.72 | 0.97 | 75% | 76% |
| Diuron | 180 | 660 | 2.23 | 0.90 | 91% | 90% |
| Naphthalene | 225 | 3235 | 4.32 | 0.97 | 95% | 94% |
| Biphenyl | 44 | 7079 | 19.65 | 0.99 | 99% | 97% |

Note:
^{a}average percent HOC removal across all initial concentrations tested in the absence of HA.
^{b}Percent HOC removal at highest initial HOC concentrations in the presence HA (20 mg/L).

Humic acid constitutes a major fraction of surface water organic matter and of soil organic matter and is the most abundant naturally occurring organic macromolecule on earth. The structure of HA is usually described as assemblies of covalently linked aromatic and aliphatic residues, in which the aromatic fraction ranges from ca. 10-40%. On the other hand, HA is amphiphilic, containing a significant amount of polar groups (e.g., carboxylic groups) [29]. Due to the ubiquitous present of HA, in this study, the sorption of HA onto Mag-PCMAs and the effect of HA on the HOC sorption onto Mag-PCMAs were also investigated.

Our results show that the sorption of the HA onto Mag-PCMAs was insignificant (only 0.58 mg/g and less than 15% of the total was removed by Mag-PCMAs). This is not surprising because the polar groups, such as carboxylic groups, associated with HA were repelled by the confined micelles and the HA sorption was limited to the external surface of the Mag-PCMAs. Table 1 presents the percentage HOC removal by Mag-PCMAs in the presence of 20 mg/L HA. As can be seen, the sorption of HA onto the Mag-PCMAs had a minimal effect on HOC sorption, further suggesting that the sorption of HOCs and HA occur in different domains.

FIG. 13B presents the measured HOC sorption kinetics. As can be seen, for all HOCs, more than 87% sorption occurred in the first 5 minutes, 96% sorption occurred in the first 10 minutes, and 99% sorption occurred within the first 45 minutes. Compared to activated carbon, whose contaminant sorption equilibrium usually occurs after a few hours equilibration due to its large microporosity [30,31], Mag-PCMAs have very fast HOC sorption kinetics due to the large amount of surfactant micelles accessible to the HOCs in solution. Also, these results suggest that the mesostructured silica is not the limiting factor for HOC diffusion into the confined surfactant micelles. Diuron sorption kinetics in the presence of HA showed that the presence of HA had no significant effect on HOC sorption kinetics, suggesting the sorption of natural organic matter would not block the entry of HOCs into the micelles confined within the mesopores.

### Example 6

Regeneration and reuse of Mag-PCMAs. A feature of this approach is the ability to regenerate and reuse the Mag-PCMAs, using solvents to extract the HOCs without affecting the stability of the Mag-PCMAs. TG analysis has previously shown that the solvent extraction did not remove any significant amount of the confined micelles from the mesostructured silica framework.

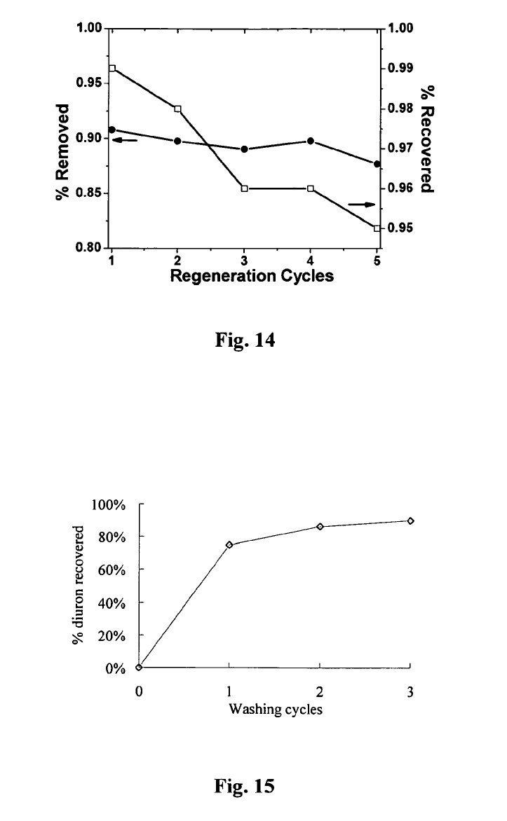

To further demonstrate the regenerability and reuseability of the Mag-PCMAs, the recovery of diuron sorbed onto the Mag-PCMAs was investigated by methanol extraction. The diuron percentages removal and percentages recovery during five continuous cycles of regeneration and reuse are shown in FIG. 14. It was found that nearly all of the sorbed HOCs (>95%) could be recovered, indicating easy regeneration of Mag-PCMAs (FIG. 14). No significant loss of HOC sorption capacity was observed on the regenerated Mag-PCMAs, which is superior to activated carbon, whose regeneration involves high temperatures that affects carbon properties and leads to a reduction of its sorption capacity.

Based on these results and the fast HOC sorption kinetics, continuous Mag-PCMAs-based flow-through or fluidized bed systems could be designed for contaminated sediment or water treatment with high HOC removal efficiency.

### Example 7

Application of Mag-PCMAs for soil treatment. Soil was first contaminated with diuron and the amount of diuron sorbed was determined to be 61 mg/kg. The sorption of HOCs onto the soil has been identified to be mainly on soil organic matter phase via hydrophobic interaction [5,26-28, 32].

FIG. 15 presents the accumulative recovery of the diuron originally sorbed with the soil by Mag-PCMAs through three treatment cycles. As can be seen, 75% of the total amount of the soil-sorbed diuron was recovered by the end of the first cycle, 86% at the end of the second cycle, and 90% at the end of third cycle. This simple test demonstrated that the Mag-PCMAs can be used for soil-washing application and the regeneration and reuse of Mag-PCMAs for soil application are promising.

Soil organic matter is a loosely packed hydrophobic medium containing an abundance of polar functional groups, while the confined TPODAC micelles are a well-ordered, rigid structure, with the hydrophobic chains of TPODAC constituting a very hydrophobic medium [33]. Thus, the affinity of confined surfactant micelles towards HOCs is expected to be much higher than for soil organic matter. For this reason, the presence of Mag-PCMAs tends to extract the originally soil-sorbed HOC out of the soil organic matter phase and into the confined micelle phase using the aqueous solution as an intermediate.

### Example 8

This example presents prospective examples of uses of magnetic micelle arrays.

(1) Mag-MCMAs can be used in combination with conventional soil washing systems. Depending on the extent of contamination, a certain amount of Mag-MCMAs are added to the washing systems and are actively mixed with HOC-contaminated soils, sediments or other media, including HOC-contaminated aqueous solutions and sludges, plastic or ceramic materials, and the like. Using the aqueous phase as intermediate, the HOCs will gradually transfer into the micelles confined within the mesoporous silica framework of the Mag-PCMAs. After sorption equilibrium has been achieved, the Mag-PCMAs can then be removed by applying an external magnetic field or simply submerging a magnet, preferably an electromagnet which can be demagnetized as needed, of sufficient capacity into the treatment system while mixing. Under active mixing, the removal of magnetic Mag-PCMAs is expected to be fast. The retracted Mag-PCMAs can then be washed with organic solvent, such as methanol, toluene, acetone, to extract the micelle-solubilized HOC into the organic solvent phase. Mag-PCMAs can then be reused for the next application. In a similar way, the magnetic mesoporous particle with grafted monolayer or polymer brush can be used to clean heavy metal contaminated soils, sediments or other heavy metal contaminated media.

(2) Mag-PCMAs can be used for in situ remediating HOC-contaminated soils, sediments or other media. Mag-PCMAs can first be dispersed in water and other dispersants and the dispersion is then injected directly into the HOC-contaminated media in situ. As Mag-PCMAs are negatively charged, they tend to be mobile and are able to transport within the media. As they move within the media, dissolved and sorbed HOCs will gradually transfer into the micelles contained within the mesoporous framework. Thus, Mag-PCMAs serve as a scavenging adsorbent for HOCs as they move through the contaminated media. A magnetic field can be applied at a collection point and the strength of the magnetic field can be adjusted to control the rate by which Mag-PCMAs move within the media. Alternatively, magnets can be buried underground down gradient of the water flow to collect the HOC loaded Mag-PCMAs. In a similar way, the magnetic mesoporous particle with grafted monolayer or polymer brush can be used to in situ remediate heavy metal contaminated soils or other media, or to remove undesirable ions.

(3) Mag-PCMAs can be placed as a barrier at a given point downstream of a contaminated region, allowing the contaminated water laden with HOCs to pass through the permeable barrier. Once the HOC sorption capacity of the Mag-PCMAs is reached, they can be removed with a magnet, and a new batch of Mag-PCMAs can be placed in the permeable barrier. The HOCs are then extracted from the Mag-PCMAs as described before. In a similar way, the magnetic mesoporous particle with grafted monolayer or polymer brush can be used to remove ionic contaminants in the permeable barrier.

(4) Mag-PCMAs can be used for ambient water remediation and for drinking water purification; Mag-MCMAs can be added to water contaminated with a wide range of hydrophobic organic compounds. The organics in the water will reach sorption equilibrium within the Mag-PCMAs. The HOC-loaded Mag-PCMAs can be removed with a magnetic field. In a similar way, the magnetic mesoporous particle with grafted monolayer or polymer brush can be used to remove ionic contaminants from aqueous media.

(5) Another use of Mag-PCMAs is enrichment of HOC from aqueous environmental samples for instrumental analysis, such as HPLC or GC/MS. Conventional HOC enrichment technique for environmental aqueous samples is solid-phase extraction, which involves using C8, C12 or C18 extraction discs. The extraction procedure is tedious and labor-intensive, including filtration. The use of Mag-PCMAs can overcome these drawbacks and thus reduce the analytical costs.

### Example 9

Examples 9-12 concern carbon nanotubes and other nanoparticles that are removed by using magnetic nanoparticles.

Carbon Nanotubes (CNTs). Highly purified single-walled carbon nanotubes (SWCNTs) obtained from Tubes@Rice were synthesized by the HiPco process, with about 2 nm diameters, and were used as received. Multi-walled carbon nanotubes (MWCNTs), purchased from MER Corp, were produced by chemical vapor deposition (CVD) method, with a purity >90% and less than 0.1% metal (Fe) content, and were used as received. The MWCNTs were 35±10 nm in diameter.

Humic Acid (HA). HA was purchased from MP Biomedicals, Inc., with a purity >99%. The HA was composed of 49.5 wt % carbon, 43.3 wt % oxygen, 5.1 wt % hydrogen. The HA was reported to have no regular structures. However, it contained aromatic rings and abundant hydrophilic functional groups, such as carboxylic acid, phenolic hydroxyl, aliphatic hydroxyl, and so on. A stock solution of 200 mg/L was prepared by dissolving the HA solid in DI water and filtering the solution through a 0.45 μm nylon membrane filter.

### Example 10

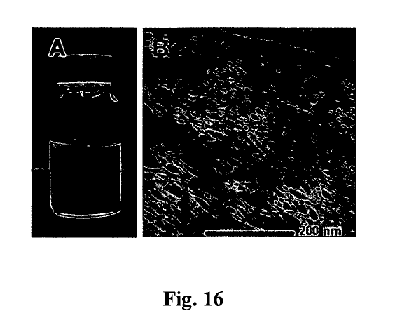

Preparation of the HA-stabilized CNT dispersion. The HA-Stabilized CNT dispersion was prepared by adding a constant amount (5.0 mg) of SWCNTs or MWCNTs into 30 ml of an HA solution at different HA concentrations (25.0, 15.0, 10.0 mg/L) in 40 ml glass vials. The CNTs and HA mixtures were then sonicated by using a low-power bath sonicator (50 W) for 60 minutes, followed by agitation in an end-over-end shaker at 60 rpm for 24 hours. The mixtures were then centrifuged at 10,000 RCF to remove undispersed CNT aggregates and the supernatant, containing stably dispersed CNTs, was carefully decanted for further analysis. Due to the small diameter of the CNTs used, filtration through a 0.45 μm filter cannot separate the unbound HA from the HA-stabilized CNTs, so no effort was taken to measure the adsorption density of HA onto the CNTs. The concentration of the HA-stabilized CNTs was determined by freeze-drying a measured volume of supernatant, weighing the final product, subtracting the amount of HA (bound and unbound) to get the amount of the CNTs stabilized by HA, and dividing the mass of CNTs by the volume of supernatant to determine the concentration of stabilized CNTs. UV-VIS absorption spectroscopy was also used to determine the solubility. FIG. 16A presents an image of HA-stabilized SWCNT dispersion with the concentration of 53 mg/L, and FIG. 16B presents an SEM image of freeze-dried cotton-like HA-stabilized SWCNTs, consisting of interweaved thin bundles or individual tubes.

### Example 11

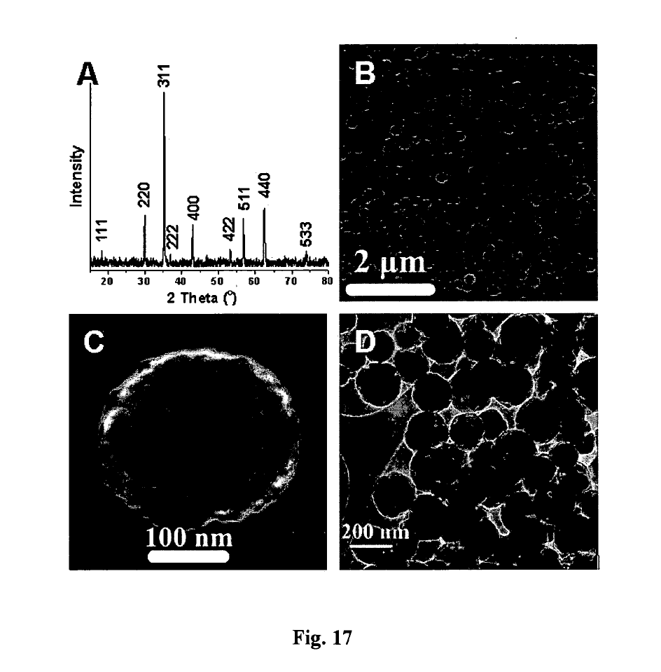

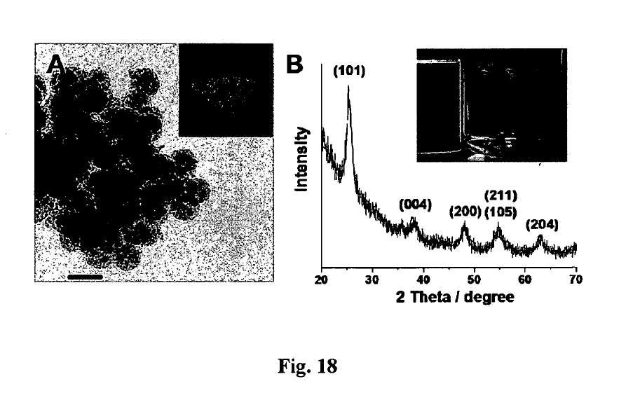

Synthesis of Fe₃O₄ nanoparticles (Fe-NPs). FeCl₃.6H₂O (1.35 g, 5 mmol) was dissolved in ethylene glycol (40 mL) to form a clear solution, followed by addition of sodium acetate (3.6 g). The mixture was stirred vigorously for 60 min and then sealed in a teflon-lined stainless-steel autoclave (50 mL capacity). The autoclave was heated to and maintained at 200° C. for 8-72 h, then allowed to cool to room temperature. The black products were washed several times with ethanol and degassed Milli-Q water, then dried at 60° C. for 6 hours. FIG. 17A is an XRD pattern, FIGS. 17B and 17C are SEM images, and FIG. 17D is a TEM image of the prepared Fe₃O₄ nanoparticles.

Synthesis of superparamagnetic γ-Fe₂O₃@SiO₂@ TiO₂ nanoparticles (Ti-NPs). γ-Fe₂O₃@SiO₂ core/shell nanoparticles were prepared according to previous literature method [34]. To coat a layer of titania on the γ-Fe₂O₃@SiO₂ particles, 0.36 g of particles were dispersed in 25 mL of ethanol containing 0.125 mL of 4 wt % Brij 30 aqueous solution and stirred for 30 min, followed by adding 0.72 mL of titanium butoxide, and continued stirring overnight. The products were collected by centrifugation and re-dispersed in 25 ml of water for aging. The aging step was carried out at room temperature for 2 h. The products were then calcined at 450° C. under air for 6 h for the crystallization. The calcined nanoparticles were washed with water and ethanol and collected by magnetic separation for several cycles. FIG. 18A is a TEM image of γ-Fe₂O₃@SiO₂@TiO₂ nanoparticles (Scale bar: 100 nm), where the inset is a digital image of the core/shell nanoparticle powder, while FIG. 18B is an XRD pattern of γ-Fe₂O₃@SiO₂@TiO₂ nanoparticles, where the inset is an image of superparamagnetic nanoparticles attracted by a magnet.

### Example 12

Removal of HA-stabilized CNTs from aqueous solution by Fe-NPs and Ti-NPs. The stabilized HA-stabilized CNT removal experiments were conducted by adding a suspension containing 0.1 g of Fe-NPs or Ti-NPs into 100 ml of 35 mg/L HA-stabilized CNT solution and mix for varying time. The nanoparticles were then separated via an external magnetic field and the supernatant was collected for CNT concentration measurements. The CNT removal efficiency was calculated from the final CNT concentration after nanoparticle adsorption and the initial CNT concentration. The CNT concentration was determined by US-V is adsorption spectroscopy, as described before. All experiments were performed in duplicate and the averaged values were taken and are reported here

Although the present invention has been described in connection with the preferred embodiments, it is to be understood that modifications and variations may be utilized without departing from the principles and scope of the invention, as those skilled in the art will readily understand.

The following references are incorporated by reference herein:
1. Saichek, R. E.; Reddy, K. R. 2005. Electrokinetically enhanced remediation of hydrophobic organic compounds in soils: a review, Critical Reviews in Environmental Science and Technology 35, 115-192.
2. Wang, P.; Keller, A. A. 2008. Partitioning of hydrophobic organic compounds within soil-water-surfactant systems. Water Research 42, 2093-2101.
3. Sun, S. B.; Inskeep, W. P.; Boyd, S. A. 1995. Sorption of nonionic organic compounds in soil-water systems containing a micelle forming surfactant. Environ. Sci. Technol. 29, 903-913.
4. Sanchez-Camazano, M,; Rodriguez-Cruz, S.; Sanchez-Martin, M. 2003. Evaluation of component characteristics of soil-surfactant-herbicide system that affect enhanced desorption of linuron and atrazine preadsorbed by soils. Environ. Sci. Technol. 37, 2758-2766.
5. Wang, P.; Keller, A. A. 2008. Particle-size dependent sorption and desorption of pesticides within a water-soil-nonionic surfactant system. Environ. Sci. Technol. 42, 3381-3387.
6. Wang, P.; Keller, A. A. 2008. Particle-size dependent sorption and desorption of pesticides within a water-soil-cationic surfactant system. Water Research 10.1016/j.watres.2008.07.008, in press.
7. Boyd, S. A., Lee, J. F.; Mortland, M. M. 1988. Attenuating organic contaminant mobility by soil modification. Nature 333, 345-347.
8. Sheng, G. Y., Xu, S. H., Boyd, S. A. 1996. Mechanism(s) controlling sorption of neutral organic contaminants by surfactant-derived and natural organic matter. Environ. Sci. Technol. 30, 1553-1557.
9. Jafvert, C. T., Heath, J. K. 1991. Sediment- and saturated-soil-associated reactions involving an anionic surfactant (dodecylsulfate) 1. precipitation and micelle formation. Environ. Sci. Technol. 25, 1031-1039.
10. Jafvert, C. T. 1991. Sediment- and saturated-soil-associated reactions involving an anionic surfactant (dodecylsulfate) 2. partition of PAH compounds among phases. Environ. Sci. Technol. 25, 1039-1045.
11. Thayer, A. M. C&EN 2007, 85, 29.
12. B. Nowack, T. D. Bucheli, Environ. Pollut. 2007, 150, 5.
13. Girifalco, L. A.; Hodak, M.; Lee, R. S. Phys. Rev. B 2000, 62, 13104.
14. Lewinski, N.; Colvin, V.; Drezek, R. Small, 2008, 4, 26.
15. Hyung, H.; Fortner J. D., Hughes, J. B.; Kim, J. H. Environ. Sci. Technol. 2007, 41, 179.
16. Liu, Y. Q.; Gao, L.; Zheng, S.; Wang, Y.; Sun, J.; Kajiura, H.; Li, Y. M.; Noda, K. Nanotechnology 2007,18, 365702.
17. Monnier, A.; Schüth, F.; Huo, Q.; Kumar, D.; Margolese, D.; Maxwell, R. S.; Stucky, G. D.; Krishnamurty, M.; Petroff, P.; Firouzi, A.; Janicke, M.; Chmelka, B. F. 1993. Cooperative formation of inorganic-organic interfaces in the synthesis of silicate mesostructures. Science 261, 1299-1303.
18. Deng, Y.; Qi, D.; Deng, C.; Zhang, X.; Zhao, D. Superparamagnetic High-Magnetization Microspheres with an Fe3O4@SiO2 Core and Perpendicularly Aligned Mesoporous SiO2 Shell for Removal of Microcystins. J. Am. Chem. Soc. 2008, 130, 28-29.
19. Andersson, L.; Porath, J. Anal. Biochem. 1986, 154, 250.
20. Posewitz, M. C.; Tempst, P. Anal. Chem. 1999, 71, 2883.
21. (a) Chen, C. T.; Chen, Y. C. Anal. Chem. 2005, 77, 5912; (b) Chen, C. T.; Chen, W. Y.; Tsai, P. J.; Chien, K. Y.; Yu, J. S.; Chen, Y. C. J. Proteome Res. 2007, 6, 316; (c) Lo, C. Y.; Chen, W. Y.; Chen, C. T.; Chen, Y. C. J. Proteome Res. 2007, 6, 887.
22. Yantasee, W.; Warner, C. L.; Sangvanich, T.; Addleman, R. S.; Carter, T. G.; Wiacek, R. J.; Fryxell, G. E.; Warner, M. G. Environ. Sci. Technol. 2007, 41, 5114.
23. Deng, H.; Li, X. L.; Peng, Q.; Wang, X.; Chen, J. P.; Li, Y. D. Angew. Chem. Int. Ed. 2005, 44, 2782.
24. Ulman, A. An Introduction to Ultrathin Organic Films, from Langmuir-Glodgett to Self-Assembly; Academic Press: San Diego, 1991; pp 239-245.
25. Zhao, W.; Gu, J.; Zhang, L.; Chen, H.; Shi, J. J. Am. Chem. Soc. 2005, 127, 8916-8917.
26. Schwarzenbach R. P.; Gschwend, P. M.; Imboden, D. M. Environmental Organic Chemistry, Second Edition, 2003.
27. Chiou, C. T.; Porter, P. E.; Schmedding, D. W. Environ. Sci. Technol. 1983,17, 227-231.
28. Karickhoff, S. W.; Brown, D. S.; Scott, T. A. Water Res. 1979, 13, 241-248.
29. Tan, K. H. Humic matter in soil and the environment, Marcel Dekker, Inc. New York, 2003.
30. Zhang, Y. P.; Zhou, J. L. Water Research 2005, 39, 3991-4003.
31. Bandosz, T. J. Activated Carbon Surfaces in Environmental Remediation, 2006, Academic Press.
32. Chiou, C. T.; Peters, L. J.; Freed, V. H. Science 1979, 206, 831-832.
33. Sheng, G. Y.; Xu, S. H.; Boyd, S. A. Environ. Sci. Technol. 1996, 30, 1553-1557.
34. Yi, D. K.; Selvan, S. T.; Lee, S. S.; Papaefthymiou, G. C.; Kundaliya, D.; Ying, J. Y., J. Am. Chem. Soc. 2005, 127, 4990.

What is claimed is:

1. A method of removing a contaminant from its environment, the method comprising:
a) forming a magnetic composition comprising the contaminant and an amphiphilic substance; and
b) applying a magnetic field to the magnetic composition so as to separate the magnetic composition from the environment.

2. The method of claim 1, wherein the contaminant is a hydrophobic organic compound (HOC).

3. The method of claim 2, wherein forming the magnetic composition comprises adsorbing the hydrophobic organic compound into a micelle array confined in a magnetic mesoporous framework.

4. The method of claim 3, wherein the micelle array comprises a surfactant.

5. The method of claim 3, wherein micelles of the micelle array are physically confined within the mesoporous framework.

6. The method of claim 3, wherein micelles of the micelle array are chemically confined within the mesoporous framework.

7. The method of claim 2, wherein the magnetic composition further comprises a grafted monolayer or a polymer brush for enabling heavy metal decontamination and organic matter removal.

8. The method of claim 2, wherein the magnetic composition comprises a core/shell structure.

9. The method of claim 8, wherein the core/shell structure comprises an iron oxide core, a silica mesoporous framework, and a cationic surfactant-containing micelle array.

10. The method of claim 3, wherein the micelle array is part of a nanoparticle or a microparticle.

11. The method of claim 1, wherein the contaminant is in the form of a nanoparticle.

12. The method of claim 11, wherein the nanoparticle is a single-walled carbon nanotube, a multi-walled carbon nanotube, a fullerene, carbon black or a carbon black-type material, or a boron nitride particle, or a derivative or combination thereof.

13. The method of claim 11, wherein forming the magnetic composition comprises adhering an amphiphilic material comprising functional surface groups to the contaminant, then interacting a magnetic material with the functional surface groups of the amphiphilic material.

14. The method of claim 13, wherein the amphiphilic material is natural organic matter, humic acid, a synthetic polymer, or a surfactant, or a combination thereof.

15. The method of claim 13, wherein the magnetic material comprises particles containing a magnetic core.

16. The method of claim 13, wherein the magnetic material is selected from an oxide, a nitride, a metal, or a metal alloy, or a combination thereof.

17. The method of claim 13, wherein the magnetic material is selected from magnetite, maghemite, Ni, Co, Fe, FePt, CoPt, FePd, or CoPd, or a combination thereof.

18. The method of claim 13, wherein the magnetic material is in the form of a nanoparticle or a microparticle.

19. The method of claim 1, wherein the environment comprises contaminated water, contaminated soil, or contaminated sediment, or a combination thereof.

20. The method of claim 1, wherein the magnetic composition is in the form of a nanoparticle or a microparticle.

21. A composition comprising a micelle array confined in a magnetic mesoporous framework.

22. The composition of claim 21, wherein the micelle array comprises a surfactant.

23. The composition of claim 22, wherein micelles of the micelle array are physically confined within the mesoporous framework.

24. The composition of claim 22, wherein micelles of the micelle array are chemically confined within the mesoporous framework.

25. The composition of claim 21, further comprising a grafted monolayer or polymer brush for enabling heavy metal decontamination and organic matter removal.

26. The composition of claim 21, wherein the composition comprises a core/shell structure.

27. The composition of claim 26, wherein the core/shell structure comprises an iron oxide core, a silica mesoporous framework, and a cationic surfactant-containing micelle array.

28. The composition of claim 21, wherein the composition is in the form of a nanoparticle or a microparticle.

29. A method of producing a magnetic micelle array, comprising:
a) preparing a magnetic particle;
b) mixing a surfactant and a mesoporous framework-forming substance with the magnetic particle in such a way that surfactant micelles confined in a mesoporous framework are produced on the surface of the magnetic particle.

30. The method of claim 29, wherein preparing the magnetic particle comprises preparing a core magnetic particle and reversing surface charges of the core magnetic particle.

31. The method of claim 29, wherein the magnetic micelle array is in the form of a nanoparticle or a microparticle.

32. The method of claim 29, wherein the mesoporous framework-forming substance is a silica-based substance.

33. The method of claim 29, wherein the magnetic particle comprises an iron oxide, the surfactant is a cationic surfactant, and the mesoporous framework produced on the surface of the magnetic particle is a silica mesoporous framework.

34. A method of removing a contaminant from a liquid, comprising passing a solution of an amphiphilic compound-stabilized nanoparticle through a chromatographic column comprising silica coated with a material that interacts with functional surface groups of the amphiphilic compound.

35. A method of enriching for a hydrophobic organic compound, said method comprising:
a) adsorbing the hydrophobic organic compound into a micelle array confined in a magnetic mesoporous framework; and
b) applying a magnetic field to select for the hydrophobic organic compound.

36. A method of enriching for a composition that comprises single-walled carbon nanotubes, multi-walled carbon nanotubes, fullerenes, carbon black or a carbon black-type material, or boron nitride particles, or a derivative or combination thereof, said method comprising:
a) adhering an amphiphilic material comprising functional surface groups to the composition;
b) interacting a magnetic material with the functional surface groups of the amphiphilic material; and
c) applying a magnetic field to select for the composition.
